(19) United States
(12) Patent Application Publication
(10) Pub. No.: US 2015/0120590 A1
(43) Pub. Date: Apr. 30, 2015

(54) METHOD AND SYSTEM FOR GENERATING HUMAN RESOURCES VALUE RECOMMENDATIONS

(71) Applicant: salesforce.com, inc., San Francisco, CA (US)

(72) Inventors: Jager McConnell, San Francisco, CA (US); Ciara Peter, San Francisco, CA (US)

(73) Assignee: salesforce.com, inc., San Francisco, CA (US)

(21) Appl. No.: 14/063,590

(22) Filed: Oct. 25, 2013

(51) Int. Cl. G06Q 10/10

(52) U.S. Cl. CPC G06Q 10/105
USPC 705/320

(57) ABSTRACT

Systems and methods are provided for human resources value recommendations. A system identifies a department of multiple departments in an enterprise for adding value. The system identifies a change in human resources in the department that meets a value threshold based on an estimated benefit and an estimated cost associated with the change in human resources. The system outputs, via a user interface, a recommendation for the change in human resources.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### HUMAN RESOURCES VALUE RECOMMENDATIONS

One or more implementations relate generally to generating human resources value recommendations.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Human resource management is the coordination of an enterprise's workforce, or human resources. Human resource management is typically responsible for the attraction, selection, training, assessment, and rewarding of employees. Human resource management began in the early 20th century, when researchers began documenting ways of creating business value through the strategic management of the workforce. In startup enterprises, human resource management may be performed by a few trained professionals, while in larger enterprises, an entire functional group is typically dedicated to the discipline, with staff specializing in various human resource management tasks and functional leadership engaging in strategic decision making across the enterprise. A human resource management department may be involved in the hiring of employees for many different departments in an enterprise. However, hiring decisions may be based on how persuasive a head of a department is when presenting a hiring request to the enterprise's chief executive officer, without being able to completely evaluate the benefits and the costs of the prospective hiring, and without being able the completely evaluate the effects of the prospective hiring on other departments in the enterprise. Accordingly, it is desirable to provide techniques that enable a database system to provide human resources value recommendations.

### BRIEF SUMMARY

In accordance with embodiments, there are provided systems and methods for human resources value recommendations. A system identifies a department of multiple departments in an enterprise for adding value. For example, the system receives a request from the head of the lead generation department via her user interface to identify the lead generation department for adding value. The system identifies a change in human resources in the department that meets a value threshold based on an estimated benefit and an estimated cost associated with the change in human resources. For example, the system identifies the hiring of one product development engineer for the product development department, the hiring of one new junior lead generator and the promoting of an existing junior lead generator to senior lead generator for the lead generation department, the hiring of three new entry level salespeople for the sales department, and no hiring of any customer support staff for the customer support department. In this example, the system identifies the hiring of one new junior lead generator because full time junior lead generators average more than fifteen lead generations per week, which on average led to an average weekly increase in revenue that was at least a thousand dollars greater than the weekly salary and benefits package for a full time junior lead generator. The system outputs, via a user interface, a recommendation for the change in human resources. For example, the system outputs a newsfeed recommendation to the user interfaces for the heads of the lead generation department, the human resources department, the product development department, the sales department, and the customer support department for the hiring of one product development engineer for the product development department, the hiring of one new junior lead generator and the promoting of an existing junior lead generator to senior lead generator for the lead generation department, the hiring of three new entry level salespeople for the sales department, and no hiring of any customer support staff for the customer support department. Accordingly, systems and methods are provided which enable a database system to provide human resources value recommendations.

While one or more implementations and techniques are described with reference to an embodiment in which human resources value recommendations is implemented in a system having an application server providing a front end for an on-demand database service capable of supporting multiple tenants, the one or more implementations and techniques are not limited to multi-tenant databases nor deployment on application servers. Embodiments may be practiced using other database architectures, i.e., ORACLE®, DB2® by IBM and the like without departing from the scope of the embodiments claimed.

Any of the above embodiments may be used alone or together with one another in any combination. The one or more implementations encompassed within this specification may also include embodiments that are only partially mentioned or alluded to or are not mentioned or alluded to at all in this brief summary or in the abstract. Although various embodiments may have been motivated by various deficiencies with the prior art, which may be discussed or alluded to in one or more places in the specification, the embodiments do not necessarily address any of these deficiencies. In other words, different embodiments may address different deficiencies that may be discussed in the specification. Some embodiments may only partially address some deficiencies or just one deficiency that may be discussed in the specification, and some embodiments may not address any of these deficiencies.

### BRIEF DESCRIPTION OF THE DRAWINGS

In the following drawings like reference numbers are used to refer to like elements. Although the following figures depict various examples, the one or more implementations are not limited to the examples depicted in the figures.

FIG. 1 is an operational flow diagram illustrating a high level overview of a method for human resources value recommendations in an embodiment;

FIG. 2 is a screen shot illustrating a frame of an example user interface screen of a display device supporting methods for human resources value recommendations;

FIG. 3 illustrates a block diagram of an example of an environment wherein an on-demand database service might be used; and

FIG. 4 illustrates a block diagram of an embodiment of elements of FIG. 3 and various possible interconnections between these elements.

### DETAILED DESCRIPTION

### General Overview

Systems and methods are provided for human resources value recommendations.

As used herein, the term multi-tenant database system refers to those systems in which various elements of hardware and software of the database system may be shared by one or more customers. For example, a given application server may simultaneously process requests for a great number of customers, and a given database table may store rows for a potentially much greater number of customers. As used herein, the term query plan refers to a set of steps used to access information in a database system.

Next, mechanisms and methods for human resources value recommendations will be described with reference to example embodiments.

The following detailed description will first describe a method for human resources value recommendations.

Next, a screen shot illustrating a frame of an example user interface screen is described.

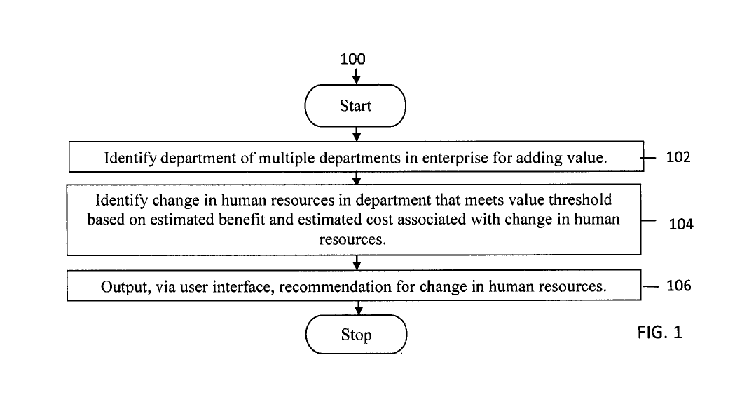

FIG. 1 is an operational flow diagram illustrating a high level overview of a method 100 for human resources value recommendations. As shown in FIG. 1, a database system can provide human resources value recommendations.

In block 102, a department of multiple departments in an enterprise is identified for adding value. For example and without limitation, this can include the database system receiving a request from the head of the lead generation department via her user interface to identify the lead generation department for adding value. Although this example describes the database system responding to a request from a user to identify a department for adding value, the database system may automatically review departments for adding value based on a schedule or an event, such as the hiring or firing of any employees.

A user interface may present a user with a number of check boxes to select, which guides the database system in analyzing departments for adding value. For example, the head of the lead generation department may propose a prospective hiring of three senior lead generators, and the database system may conduct a cost/benefit analysis of this prospective hiring and recommend against this prospective hiring based on an estimation of an overall loss of value due to the compensation and benefits required to hire and retain three senior lead generators.

In block 104, a change in human resources in the department is identified that meets a value threshold based on an estimated benefit and an estimated cost associated with the change in human resources. By way of example and without limitation, this can include the database system identifying the hiring of one product development engineer for the product development department, the hiring of one new junior lead generator and the promoting of an existing junior lead generator to senior lead generator for the lead generation department, the hiring of three new entry level salespeople for the sales department, and no hiring of any customer support staff for the customer support department.

In this example, the database system identifies the hiring of one new junior lead generator because full time junior lead generators average more than fifteen lead generations per week, which on average led to an average weekly increase in revenue that was at least a thousand dollars greater than the weekly salary, benefits package, prospective future promotions, and stock options for a full time junior lead generator.

In another example, the database system recommends promoting an existing junior lead generator to senior lead generator because the existing junior lead generator averages more than twenty lead generations per week. The database system determines that previous junior lead generators who averaged more than twenty lead generations per week and were promoted to senior lead generator increased the revenue associated with their lead generation efforts by more than two thousand dollars per week greater than the increase in weekly salary and benefits from a junior lead generator to a senior lead generator. The database system may determine that hiring a junior lead generator may provide better cost/benefit results than hiring a senior salesperson. Although these examples describe recommendations for an enterprise to hire individuals, the recommendations may be to hire full-time employees, part-time employees, contractors, or any combination thereof.

The estimated benefits and/or the estimated costs may be based on a performance factor relative to a number of full time equivalents associated with the performance factor, and the performance factor may be based on historical data and/or projected data. For example, the number of leads generated over the last four weeks may be divided by the average number of full time equivalents working over the last four weeks, taking vacations, sick time, and part time workers into account, to calculate the average number of weekly leads generated by a lead generator. In another example, the head of the sales department may project sales for a new sales territory based on sales rates for previously existing sales territories, taking into account the differences in prospective customers between the previously existing sales territories and the new sales territory.

The change in human resources may be based on a correlation with costs and/or benefits associated other departments in the enterprise, normalizing the costs and benefits between departments based on projected revenues and projected expenses. For example, if the current salespeople are converting leads into sales at a historically high rate, the database system may recommend hiring more lead generators for the lead generation department to provide more leads for the salespeople in the sale department to convert into sales. In another example, the database system identifies the average spike in new product sales which eventually tapers off, identifies the average number of cycles to develop a new product, identifies the average number of number of full time equivalents for engineers working on development of a new product, divides the average number of cycles by the average number of full time equivalent engineers to estimate how many engineers need to be hired to accelerate the arrival of the new product sales spike, and conducts a cost/benefit analysis to determine whether to recommend hiring any new engineers for the product development department.

Although this example describes a recommendation to not hire any additional customer support staff, the database system can identify historical instances in which a shortage of customer support staff led to unhappy customers, which led to a loss in revenue, such that the database system correlates the number of customer support staff needed to satisfy customers with the numbers of engineers in product development, the number of lead generators, and the number of salespeople.

The database system may take other considerations into account when identifying a change in human resources for adding value, such as comparing the historical average ramp-up time for new hires against the historical average ramp-up time for internal promotions. Although the database system may take a budget into account when making recommendations for changes in personnel, the heads of departments may use the cost/benefit analysis of the recommendations to justify funding that does not currently exist in the budget. The change in human resources may specify a location associated with a change in human resources, such as identifying the hiring of a new salesperson in Japan due to a history of lost sales opportunities in Japan. The change in personnel may also be a reassignment, a demotion, or a firing.

In block 106, a user interface outputs a recommendation for the change in human resources. In embodiments, this can include the database system outputting a newsfeed recommendation to the user interfaces for the heads of the lead generation department, the human resources department, the product development department, the sales department, and the customer support department for the hiring of one product development engineer for the product development department, the hiring of one new junior lead generator and the promoting of an existing junior lead generator to senior lead generator for the lead generation department, the hiring of three new entry level salespeople for the sales department, and no hiring of any customer support staff for the customer support department.

The method 100 may be repeated as desired. Although this disclosure describes the blocks 102-106 executing in a particular order, the blocks 102-106 may be executed in a different order.

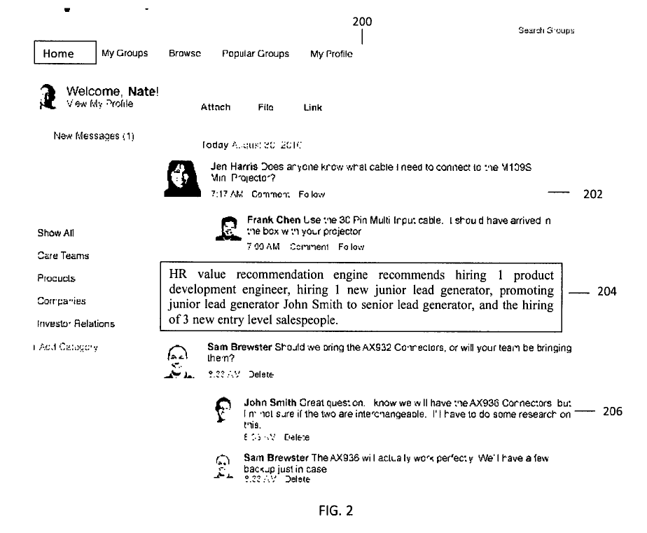

FIG. 2 is a screen shot illustrating a frame 200 of an example user interface screen of a display device for human resources value recommendations in an embodiment. The frame 200 may include a first network feed 202, a second network feed 204, and a third network feed 206. A user homepage depicted by the frame 200 enables the user to review the network feeds 202-206. The user homepage also enables the user to respond to network feeds and to generate original network feeds. Furthermore, the user homepage enables the user to search network feeds based on user-specified criteria. While the first news feed 202 and the third news feed 206 were generated by individuals, the second news feed 204 was generated by the database system. The second news feed 204 specifies that “HR value recommendation engine recommends hiring 1 product development engineer, hiring 1 new junior lead generator, promoting of junior lead generator John Smith to senior lead generator, and the hiring of 3 new entry level salespeople.”

The frame 200 may be part of a larger display screen that includes fields for users to enter commands to create, retrieve, edit, and store records. The database system may output a display screen that includes the frame 200 in response to a search based on search criteria input via a user interface. Because the frame 200 is a sample, the frame 200 could vary greatly in appearance. For example, the relative sizes and positioning of the text is not important to the practice of the present disclosure. The frame 200 can be depicted by any visual display, but is preferably depicted by a computer screen. The frame 200 could also be output as a report and printed or saved in electronic format, such as PDF. The frame 200 can be part of a personal computer system and/or a network, and operated from system data received by the network, and/or on the Internet. The frame 200 may be navigable by a user.

Typically, a user can employ a touch screen input or a mouse input device to point-and-click to a location on the frame 200 to manage the text on the frame 200, such as a selection that enables a user to edit the text. Alternately, a user can employ directional indicators, or other input devices such as a keyboard. The text depicted by the frame 200 is an example, as the frame 200 may include a much greater amount of text. The frame 200 may also include fields in which a user can input textual information.

### System Overview

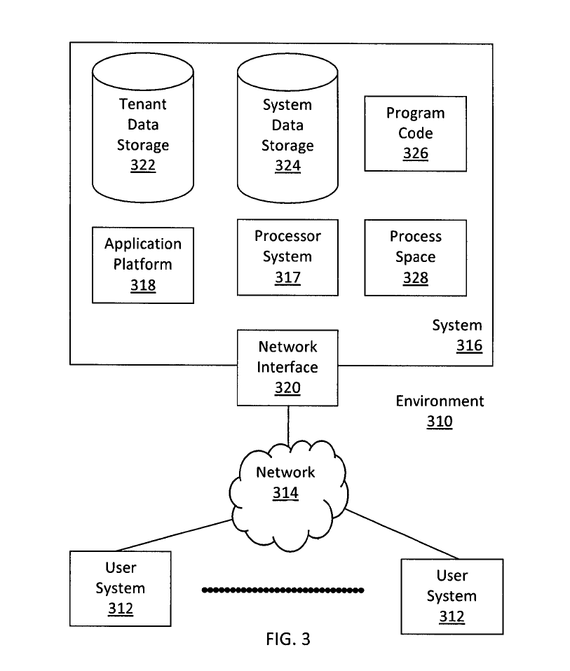

FIG. 3 illustrates a block diagram of an environment 310 wherein an on-demand database service might be used. Environment 310 may include user systems 312, network 314, system 316, processor system 317, application platform 318, network interface 320, tenant data storage 322, system data storage 324, program code 326, and process space 328. In other embodiments, environment 310 may not have all of the components listed and/or may have other elements instead of, or in addition to, those listed above.

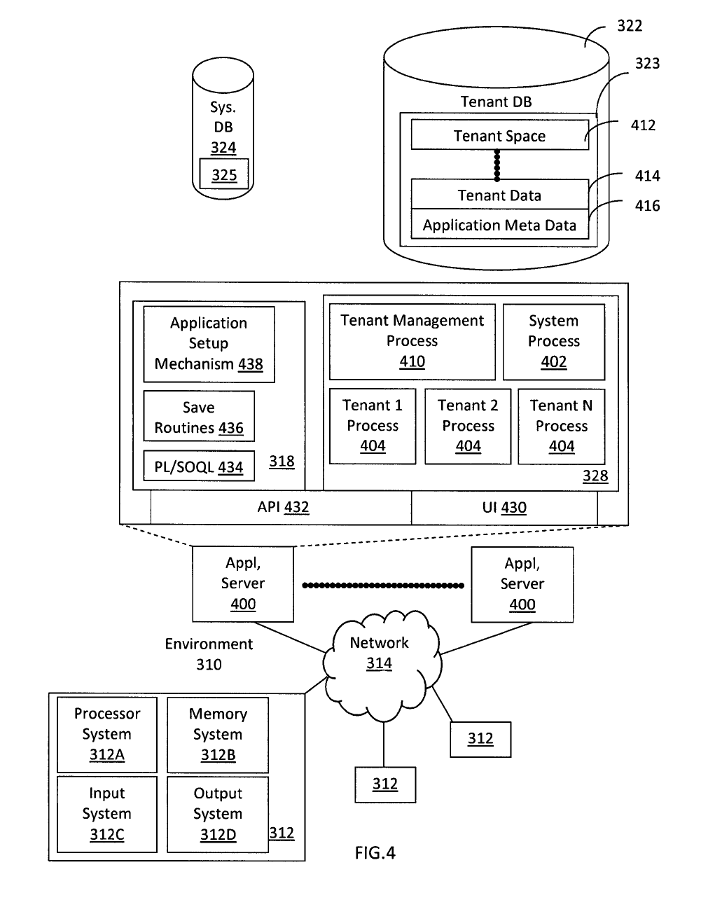

Environment 310 is an environment in which an on-demand database service exists. User system 312 may be any machine or system that is used by a user to access a database user system. For example, any of user systems 312 can be a handheld computing device, a mobile phone, a laptop computer, a work station, and/or a network of computing devices. As illustrated in FIG. 3 (and in more detail in FIG. 4) user systems 312 might interact via a network 314 with an on-demand database service, which is system 316.

An on-demand database service, such as system 316, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 316” and “system 316” will be used interchangeably herein. A database image may include one or more database objects. A relational database management system (RDMS) or the equivalent may execute storage and retrieval of information against the database object(s). Application platform 318 may be a framework that allows the applications of system 316 to run, such as the hardware and/or software, e.g., the operating system. In an embodiment, on-demand database service 316 may include an application platform 318 that enables creation, managing and executing one or more applications developed by the provider of the on-demand database service, users accessing the on-demand database service via user systems 312, or third party application developers accessing the on-demand database service via user systems 312.

The users of user systems 312 may differ in their respective capacities, and the capacity of a particular user system 312 might be entirely determined by permissions (permission levels) for the current user. For example, where a salesperson is using a particular user system 312 to interact with system 316, that user system has the capacities allotted to that salesperson. However, while an administrator is using that user system to interact with system 316, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 314 is any network or combination of networks of devices that communicate with one another. For example, network 314 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that the one or more implementations might use are not so limited, although TCP/IP is a frequently implemented protocol.

User systems 312 might communicate with system 316 using TCP/IP and, at a higher network level, use other common Internet protocols to communicate, such as HTTP, FTP, AFS, WAP, etc. In an example where HTTP is used, user system 312 might include an HTTP client commonly referred to as a “browser” for sending and receiving HTTP messages to and from an HTTP server at system 316. Such an HTTP server might be implemented as the sole network interface between system 316 and network 314, but other techniques might be used as well or instead. In some implementations, the interface between system 316 and network 314 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 316, shown in FIG. 3, implements a web-based customer relationship management (CRM) system. For example, in one embodiment, system 316 includes application servers configured to implement and execute CRM software applications as well as provide related data, code, forms, webpages and other information to and from user systems 312 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 316 implements applications other than, or in addition to, a CRM application. For example, system 316 may provide tenant access to multiple hosted (standard and custom) applications, including a CRM application. User (or third party developer) applications, which may or may not include CRM, may be supported by the application platform 318, which manages creation, storage of the applications into one or more database objects and executing of the applications in a virtual machine in the process space of the system 316.

One arrangement for elements of system 316 is shown in FIG. 3, including a network interface 320, application platform 318, tenant data storage 322 for tenant data 323, system data storage 324 for system data 325 accessible to system 316 and possibly multiple tenants, program code 326 for implementing various functions of system 316, and a process space 328 for executing MTS system processes and tenant-specific processes, such as running applications as part of an application hosting service. Additional processes that may execute on system 316 include database indexing processes.

Several elements in the system shown in FIG. 3 include conventional, well-known elements that are explained only briefly here. For example, each user system 312 could include a desktop personal computer, workstation, laptop, PDA, cell phone, or any wireless access protocol (WAP) enabled device or any other computing device capable of interfacing directly or indirectly to the Internet or other network connection. User system 312 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 312 to access, process and view information, pages and applications available to it from system 316 over network 314. Each user system 312 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 316 or other systems or servers. For example, the user interface device can be used to access data and applications hosted by system 316, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 312 and all of its components are operator configurable using applications, such as a browser, including computer code run using a central processing unit such as an Intel Pentium® processor or the like. Similarly, system 316 (and additional instances of an MTS, where more than one is present) and all of their components might be operator configurable using application(s) including computer code to run using a central processing unit such as processor system 317, which may include an Intel Pentium® processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 316 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, each system 316 is configured to provide webpages, forms, applications, data and media content to user (client) systems 312 to support the access by user systems 312 as tenants of system 316. As such, system 316 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 4 also illustrates environment 310. However, in FIG. 4 elements of system 316 and various interconnections in an embodiment are further illustrated. FIG. 4 shows that user system 312 may include processor system 312A, memory system 312B, input system 312C, and output system 312D. FIG. 4 shows network 314 and system 316. FIG. 4 also shows that system 316 may include tenant data storage 322, tenant data 323, system data storage 324, system data 325, User Interface (UI) 430, Application Program Interface (API) 432, PL/SOQL 434, save routines 436, application setup mechanism 438, applications servers 400₁-400_{N}, system process space 402, tenant process spaces 404, tenant management process space 410, tenant storage area 412, user storage 414, and application metadata 416. In other embodiments, environment 310 may not have the same elements as those listed above and/or may have other elements instead of, or in addition to, those listed above.

User system 312, network 314, system 316, tenant data storage 322, and system data storage 324 were discussed above in FIG. 3. Regarding user system 312, processor system 312A may be any combination of one or more processors. Memory system 312B may be any combination of one or more memory devices, short term, and/or long term memory. Input system 312C may be any combination of input devices, such as one or more keyboards, mice, trackballs, scanners, cameras, and/or interfaces to networks. Output system 312D may be any combination of output devices, such as one or more monitors, printers, and/or interfaces to networks. As shown by FIG. 4, system 316 may include a network interface 320 (of FIG. 3) implemented as a set of HTTP application servers 400, an application platform 318, tenant data storage 322, and system data storage 324. Also shown is system process space 402, including individual tenant process spaces 404 and a tenant management process space 410. Each application server 400 may be configured to tenant data storage 322 and the tenant data 323 therein, and system data storage 324 and the system data 325 therein to serve requests of user systems 312. The tenant data 323 might be divided into individual tenant storage areas 412, which can be either a physical arrangement and/or a logical arrangement of data. Within each tenant storage area 412, user storage 414 and application metadata 416 might be similarly allocated for each user. For example, a copy of a user's most recently used (MRU) items might be stored to user storage 414. Similarly, a copy of MRU items for an entire organization that is a tenant might be stored to tenant storage area 412. A UI 430 provides a user interface and an API 432 provides an application programmer interface to system 316 resident processes to users and/or developers at user systems 312. The tenant data and the system data may be stored in various databases, such as one or more Oracle™ databases.

Application platform 318 includes an application setup mechanism 438 that supports application developers' creation and management of applications, which may be saved as metadata into tenant data storage 322 by save routines 436 for execution by subscribers as one or more tenant process spaces 404 managed by tenant management process 410 for example. Invocations to such applications may be coded using PL/SOQL 34 that provides a programming language style interface extension to API 432. A detailed description of some PL/SOQL language embodiments is discussed in commonly owned U.S. Pat. No. 7,730,478 entitled, METHOD AND SYSTEM FOR ALLOWING ACCESS TO DEVELOPED APPLICATIONS VIA A MULTI-TENANT ON-DEMAND DATABASE SERVICE, by Craig Weissman, filed Sep. 21, 2007, which is incorporated in its entirety herein for all purposes. Invocations to applications may be detected by one or more system processes, which manages retrieving application metadata 416 for the subscriber making the invocation and executing the metadata as an application in a virtual machine.

Each application server 400 may be communicably coupled to database systems, e.g., having access to system data 325 and tenant data 323, via a different network connection. For example, one application server 400₁ might be coupled via the network 314 (e.g., the Internet), another application server 400_{N—1} might be coupled via a direct network link, and another application server 400_{N} might be coupled by yet a different network connection. Transfer Control Protocol and Internet Protocol (TCP/IP) are typical protocols for communicating between application servers 400 and the database system. However, it will be apparent to one skilled in the art that other transport protocols may be used to optimize the system depending on the network interconnect used.

In certain embodiments, each application server 400 is configured to handle requests for any user associated with any organization that is a tenant. Because it is desirable to be able to add and remove application servers from the server pool at any time for any reason, there is preferably no server affinity for a user and/or organization to a specific application server 400. In one embodiment, therefore, an interface system implementing a load balancing function (e.g., an F5 Big-IP load balancer) is communicably coupled between the application servers 400 and the user systems 312 to distribute requests to the application servers 400. In one embodiment, the load balancer uses a least connections algorithm to route user requests to the application servers 400. Other examples of load balancing algorithms, such as round robin and observed response time, also can be used. For example, in certain embodiments, three consecutive requests from the same user could hit three different application servers 400, and three requests from different users could hit the same application server 400. In this manner, system 316 is multi-tenant, wherein system 316 handles storage of, and access to, different objects, data and applications across disparate users and organizations.

As an example of storage, one tenant might be a company that employs a sales force where each salesperson uses system 316 to manage their sales process. Thus, a user might maintain contact data, leads data, customer follow-up data, performance data, goals and progress data, etc., all applicable to that user's personal sales process (e.g., in tenant data storage 322). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 316 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 316 might also maintain system level data usable by multiple tenants or other data. Such system level data might include industry reports, news, postings, and the like that are sharable among tenants.

In certain embodiments, user systems 312 (which may be client systems) communicate with application servers 400 to request and update system-level and tenant-level data from system 316 that may require sending one or more queries to tenant data storage 322 and/or system data storage 324. System 316 (e.g., an application server 400 in system 316) automatically generates one or more SQL statements (e.g., one or more SQL queries) that are designed to access the desired information. System data storage 324 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. Pat. No. 7,779,039, filed Apr. 2, 2004, entitled “Custom Entities and Fields in a Multi-Tenant Database System”, which is hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

1. A system for generating human resources value recommendations, the system comprising:
a processor; and
one or more stored sequences of instructions which, when executed by the processor, cause the processor to carry out the steps of:
identifying a department of a plurality of departments in an enterprise for adding value;
identifying a change in human resources in the department that meets a value threshold based on an estimated benefit and an estimated cost associated with the change in human resources; and
outputting, via a user interface, a recommendation for the change in human resources.

2. The system of claim 1, wherein identifying the department for adding value is in response to an input, via the user interface, that identifies the department for adding value.

3. The system of claim 1, wherein the change in personnel comprises at least one of a hiring, a promotion, a reassignment, a demotion, and a firing.

4. The system of claim 1, wherein the change in human resources further comprises at least one location associated with the change in human resources, and wherein the change in human resources is further based on a correlation with at least one of a cost and a benefit associated with at least one other department of the plurality of departments in the enterprise.

5. The apparatus of claim 1, wherein at least one of the estimated benefit and the estimated cost is based on a performance factor relative to a number of full time equivalents associated with the performance factor, and wherein the performance factor is based on at least one of historical data and projected data.

6. A computer program product, comprising a non-transitory computer-readable medium having a computer-readable program code embodied therein to be executed by one or more processors, the program code including instructions to:
identify a department of a plurality of departments in an enterprise for adding value;
identify a change in human resources in the department that meets a value threshold based on an estimated benefit and an estimated cost associated with the change in human resources; and
output, via a user interface, a recommendation for the change in human resources.

7. The computer program product of claim 6, wherein identifying the department for adding value is in response to an input, via the user interface, that identifies the department for adding value.

8. The computer program product of claim 6, wherein the change in personnel comprises at least one of a hiring, a promotion, a reassignment, a demotion, and a firing.

9. The computer program product of claim 6, wherein the change in human resources further comprises at least one location associated with the change in human resources, and wherein the change in human resources is further based on a correlation with at least one of a cost and a benefit associated with at least one other department of the plurality of departments in the enterprise.

10. The computer program product of claim 6, wherein at least one of the estimated benefit and the estimated cost is based on a performance factor relative to a number of full time equivalents associated with the performance factor, and wherein the performance factor is based on at least one of historical data and projected data.

11. A method for generating human resources value recommendations, the method comprising:
identifying a department of a plurality of departments in an enterprise for adding value;
identifying a change in human resources in the department that meets a value threshold based on an estimated benefit and an estimated cost associated with the change in human resources; and
outputting, via a user interface, a recommendation for the change in human resources.

12. The method of claim 11, wherein identifying the department for adding value is in response to an input, via the user interface, that identifies the department for adding value.

13. The method of claim 11, wherein the change in personnel comprises at least one of a hiring, a promotion, a reassignment, a demotion, and a firing.

14. The method of claim 11, wherein the change in human resources further comprises at least one location associated with the change in human resources, and wherein the change in human resources is further based on a correlation with at least one of a cost and a benefit associated with at least one other department of the plurality of departments in the enterprise.

15. The method of claim 11, wherein at least one of the estimated benefit and the estimated cost is based on a performance factor relative to a number of full time equivalents associated with the performance factor, and wherein the performance factor is based on at least one of historical data and projected data.

16. A method for transmitting code for generating human resources value recommendations on a transmission medium, the method comprising:
transmitting code to identify a department of a plurality of departments in an enterprise for adding value;
transmitting code to identify a change in human resources in the department that meets a value threshold based on an estimated benefit and an estimated cost associated with the change in human resources; and
transmitting code to output, via a user interface, a recommendation for the change in human resources.

17. The method for transmitting code of claim 16, wherein identifying the department for adding value is in response to an input, via the user interface, that identifies the department for adding value.

18. The method for transmitting code of claim 16, wherein the change in personnel comprises at least one of a hiring, a promotion, a reassignment, a demotion, and a firing.

19. The method for transmitting code of claim 16, wherein the change in human resources further comprises at least one location associated with the change in human resources, and wherein the change in human resources is further based on a correlation with at least one of a cost and a benefit associated with at least one other department of the plurality of departments in the enterprise.

20. The method for transmitting code of claim 16, wherein at least one of the estimated benefit and the estimated cost is based on a performance factor relative to a number of full time equivalents associated with the performance factor, and wherein the performance factor is based on at least one of historical data and projected data.
